(19) United States
(12) Patent Application Publication
(10) Pub. No.: US 2006/0124705 A1
(43) Pub. Date: Jun. 15, 2006

(54) Solder reflow system and method thereof

(75) Inventors: Joseph Kuczynski, Rochester, MN (US); Arvind Kumar Sinha, Rochester, MN (US); Timothy Jerome Tofil, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/008,769

(22) Filed: Dec. 9, 2004

(51) Int. Cl. B23K 31/02

(52) U.S. Cl. 228/221

(57) ABSTRACT

A reflow heating system includes a housing assembly defining an internal thermal processing chamber that encapsulates at least a microelectronic assembly on a substrate. A first heating source is coupled to the housing assembly and within the thermal processing chamber. The first heating source is biased by a force-applying assembly into engagement with the microelectronic assembly. The first heating source comprises one or more heating platens adapted to engage the microelectronic assembly for applying direct heat sufficient to melt solder. A vacuum assembly is incorporated in the heating platen for allowing application of at least a partial vacuum to the microelectronic assembly to permit withdrawal thereof from the substrate. A radiant heating source is applied beneath the substrate and a directional heating source is applied to the microelectronic assembly.

### BACKGROUND

The present invention relates generally to an improved heating system and method of controlling a solder reflow process.

Printed circuit boards are commonly fabricated using the reflow solder technique. Many modern semiconductor devices are constructed to be attached to a higher level of assembly by means of solder balls. Solder balls are formed on the surface of the substrate forming the semiconductor device. Typically, those solder balls are formed on contact pads on the surface of a substrate, as those contact pads form the external connection with the internal circuitry of the substrate.

However, some semiconductors are not satisfactorily bonded in the process and/or might be otherwise be damaged. Therefore, a need exists for a method of replacement or remounting. As a result, they are removed and re-soldered to the board. Because of environmental concerns regarding the use of lead in conventional soldering materials, there is a continuing trend to utilize lead-free materials for joining electronic devices to a printed wiring board and the like. While lead based solder has a melting temperature of about 185° C., the lead-free approaches tend to have significantly higher temperatures, for example in the order to about 220-250° C. It will be appreciated, therefore, that it is extremely important that a high degree of control be maintained in order to affect the successful transfer of solder to the contact pads without the significantly higher temperatures damaging the surrounding components. Accordingly, higher temperatures require different approaches than those used conventionally for effecting reflow.

Without the ability to effectively heat the lead-free solder-based materials, and at the same time minimize the damage to surrounding board components, the desirability of effective and controlled heating of lead-based materials may not be effectively and efficiently met.

### SUMMARY OF THE INVENTION

The present invention is related to a method and system for effecting an improved reflow process without negative effect and that overcome many of the disadvantages of the prior art.

In one exemplary embodiment there is provided a reflow heating system that includes a heating housing assembly defining an internal thermal processing chamber. The thermal processing chamber is adapted to generally encapsulate at least a microelectronic assembly that is to be solder mounted on a substrate. A first heating source may comprise a heating platen or element adapted to engage a surface of the microelectronic assembly in order to apply direct heat on the microelectronic assembly sufficient to melt solder.

In another exemplary embodiment, provision is made for a heating system wherein a heating platen is biased into engagement with a surface of the microelectronic assembly, and a source of vacuum allows establishment of suction between the platen, whereby the microelectronic assembly may be removed from the substrate in response to application of the vacuum source.

In an illustrated embodiment there is further included a radiant or second heat source positionable beneath the microelectronic assembly and the substrate.

In another illustrated embodiment, provision is made for a directional heating source that is movable to preselected areas of the mounted microelectronic assembly. In addition, a source of vacuum is also movable to preselected areas of the mounted microelectronic assembly to allow selective soldering.

An aspect of this invention is that it satisfactorily addresses problems of controlling solder reflow of microelectronic assemblies while preventing degradation to components surrounding the microelectronic assemblies on a substrate.

Another aspect of this invention is that it enhances versatility of controlling solder reflow of microelectronic assemblies in a variety of environments.

These and other aspects of the present invention will be more fully understood from the following detailed description of the preferred embodiments that should be read in light of the accompanying drawings. It should be understood that both the foregoing description and the following detailed description are exemplary and not restrictive.

### BRIEF DESCRIPTION OF THE DRAWINGS

FIG. 1 is a diagrammatic illustration of a cross-sectional view of one preferred embodiment of a heating system according to the present invention

FIG. 2 illustrates a plan view of certain components of a diagrammatic illustration in FIG. 1 of the present invention.

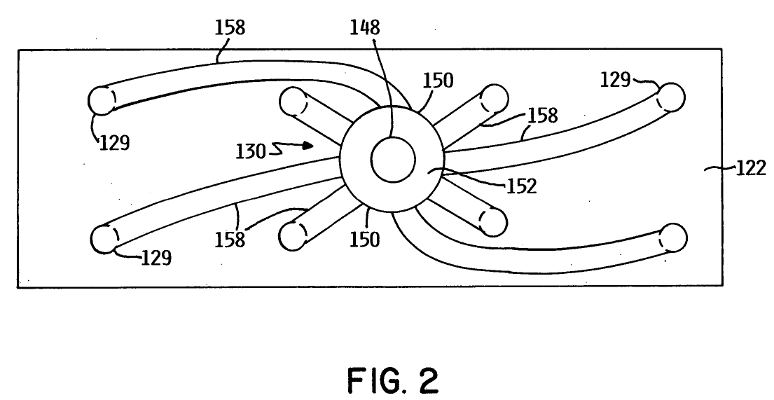

### DETAILED DESCRIPTION

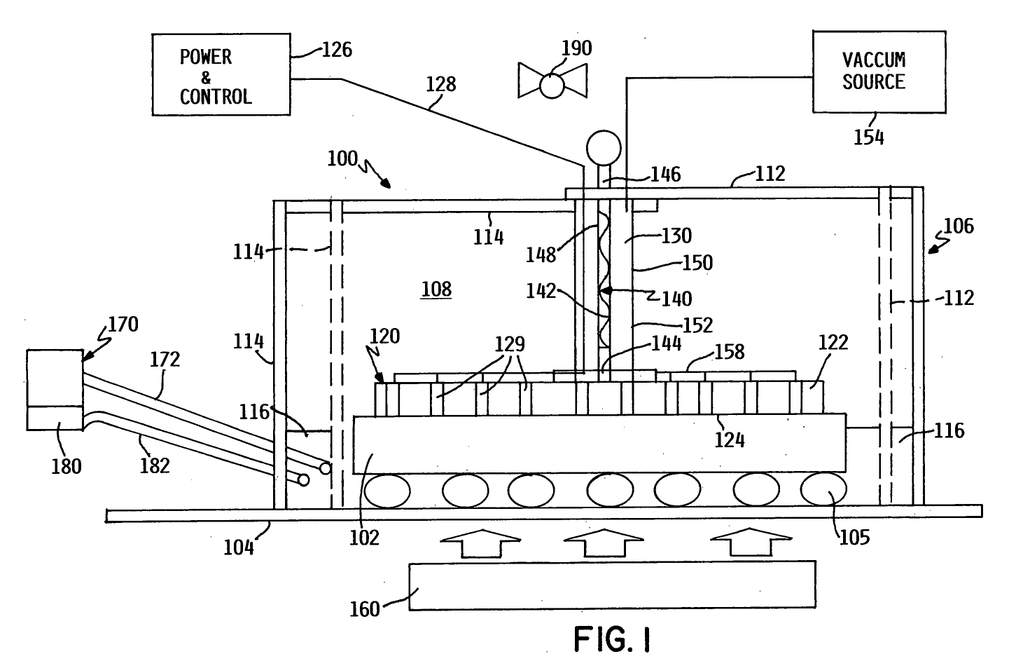

Reference is made is made to FIGS. 1 & 2 for illustrating one preferred embodiment of a solder reflow heating system 100 that is adapted for use in implementing a solder reflow process. The solder reflow heating system 100 operates to efficiently effect solder reflow without the permitting degradation to microelectronic assemblies subject to the reflow process and those objects immediately surrounding the former.

The solder reflow heating system 100 is versatile in that it may adapted to encapsulate one or more microelectronic assemblies or microelectronic assemblies 102 (only one is shown) that are solder mounted via solder balls 105 on a substrate 104. In this embodiment, the substrate 104 is a printed circuit board 104 that may be any conventional board on which the heat-producing electronic/electrical microelectronic assemblies 102 are mounted. For instance, the circuit board 104 may be a printed wiring board (“PWB”) of the type commonly used in a PC. In addition, the electronic/electrical microelectronic assemblies 102 may be any type of microelectronic assembly that does not function properly if overheated. The microelectronic assemblies 102 are mechanically coupled to the circuit board 104 by conventional soldering techniques and are electrically coupled to, among other things, a power source (not shown). The microelectronic assemblies may be arranged in any suitable manner.

While the present embodiment is described in terms of effecting reflow with lead-free solder, it should be understood that the scope and teachings of the present invention are not limited to the context presented in the discussion of the preferred and alternate embodiments. Indeed, the teachings of the present invention may be applied to any sort of object for which selective and controlled heating is desired.

Included in the solder reflow heating system 100 is a portable modular type of heating housing assembly or furnace 106. To provide and enhance portability of the system of the present invention, the heating housing assembly 106 is mounted, preferably, releaseably on the circuit board 104 replacement.

The heating housing assembly 106 is particularly adapted to substantially encapsulate one or more of the microelectronic assemblies 102 within an internal thermal processing chamber 108. The heating housing assembly 106 is constructed of suitable thermal insulating material and is thereby adapted to thermally insulate surrounding microelectronic assemblies on the circuit board from the adverse affects of heating the microelectronic assembly 102. In an exemplary embodiment, as will be described, the thermal processing chamber 108 is adapted to have a variable volume. Accordingly, one or more microelectronic assemblies may be encapsulated for enhanced versatility of the present invention. In this regard, the housing assembly 106 is comprised of a pair of mating housing portions 112, 114 that are slidably arranged with respect to each other. The mating housing portions 112, 114 are, preferably, made of thermal insulation glass to facilitate a user handling and observing the reflow process consistent with the teachings of the present invention. Each of the mating housing portions 112, 114 includes an elongated slot 116. The pair of mutually cooperating and axially aligned slots 116 on the housing portions 112, 114 cooperate with each other to expand and contract in length as the housing portions 112 and 114 move away or towards each other. This allows external access to the heating chamber by external heating and vacuuming tools as will be described, whereby the entire length of the of the microelectronic assembly 102 may be treated. While a variable volume furnace is depicted, other embodiments envision fixed volume chambers as well.

In the illustrated embodiment, a first direct heating source 120 may be comprised of a generally rectangular and flat heating platen or element 122. The heating platen 122 has a flat surface 124 that is adapted to engage a surface(s) of the microelectronic assemblies 102 for imparting heat. A controlled source of electrical power 126 is coupled to the heating platen 122 by means of appropriate leads 128. The leads 128 extend from the exterior of the housing assembly through a central supporting assembly 130 for the heating platen 122 as illustrated in FIG. 1. Electrical power may be applied to the heating platen 122 to generate the kind of heat to be transferred for reheating the solder. In one embodiment, temperatures may be, preferably, in the range of 225-250° F. for heating lead-free solder. Other temperature ranges are envisioned depending on the materials being treated. In this embodiment, an aluminum-based material is selected for the heating platen 122. This is in order to provide heat transfer to the microelectronic assemblies at a rate sufficient to effect reflow. A wide variety of other materials may be used including those yet to be developed. In one embodiment, the heating platen 122 may be a single unit, but a plurality of units are contemplated including a variety of heat engaging surfaces that may have a variety of surface configurations. The heating platen 122 within the chamber generates the most heat in this process. In the present embodiment, provision is made for an integral series of suction passages 129 that allow the application of a partial vacuum therein. The partial vacuum facilitates retention of the microelectronic assemblies to the heating platen. In this manner, whenever it is desired to remove the microelectronic assemblies from the printed circuit board the vacuum is applied. Thereafter, the heating platen may be lifted following the solder reflow by the temperature applying mechanisms. The openings are appropriately spaced apart from each other to effect a firm suction gripping action over a significant area.

Within the central supporting assembly 130 of the heating platen 122 is, preferably spring-biased or loaded by a force-applying assembly 140. The force-applying assembly 140 is adapted to urge the heating platen 122 into firm engagement with the microelectronic assembly 102. The force-applying assembly 140 may include a compression spring 142 inserted between a bottom plug 144 and a threaded spring retainer member 146. The spring retainer member 146 is threadedly mounted within a central support tube 148 of the central supporting assembly 130. The central support tube 148 is located within and coaxial with an outer support tube 150. An annular space 152 is located between the support tubes 148, 150 and defines a partial vacuum conduit by which a partial vacuum from a partial vacuum source 154 may be applied to the microelectronic assembly through the platen. In this regard, at the proximal end of the support tube 150 provisions is made for a plurality of radially extending openings (not shown) in the support tube 150 that communicate with a plurality of vacuum tubes 158 made of suitable material. The vacuum tubes 158 are inserted and sealed within the upper portions of the suction passages 129. As noted, the suction passages 129 are effective in distributing a vacuum hold-down force over the microelectronic assembly 102. As a result, there is provided a vacuum communication between the vacuum source and the microelectronic assembly. As noted, the vacuum is applied when the microelectronic assembly has had the solder completely reflow thereby facilitating removal of the microelectronic assembly. The central supporting assembly 130 is mounted of selective vertical movement relative to the housing assembly. When the vacuum is released, the microelectronic assembly may be released from the heating platen.

The heating system 100 may include a second heating source 160, such as a burner 160, preferably, positioned exterior to and beneath the microelectronic assembly 102 that is being treated by the first heating source. The burner 160 is for applying convective heat to a bottom surface of the substrate that is beneath the mounted microelectronic assembly 102. The purpose of the second heating source 160 is to further assist in ensuring that the reflow process is completed in a timely manner. The burner 160 provides additional heating and in the process reduces the amount of time that is necessary for effecting the reflow. In the illustrated embodiment, various temperatures may be applied and in the illustrated embodiment the temperature is about 225-250° F. While the second heating source is preferable, it is not mandatory. Other known or yet to be developed equivalent heat sources are contemplated. While the second heating source is a radiant heat source, the present invention is not so limited.

A third heating source 170 is contemplated by the present invention. The third heating source 170 may be a wand 172 emitting a jet of heated gas at a temperature of about 225-250° F. for reflow. The wand 172 is adapted to pass thru the slots 116 and access the microelectronic assembly 102 for heating solder around the latter during the reflow process. It will be appreciated that a user will hold the wand 172 outside the heating housing assembly and move it relative to the elongated slots 116. The wand 172 allows selective heating to occur to zones of the microelectronic assembly 102 that are not completely reflowed. This ensures a complete solder reflow. The wand 172 may be a commercial type. Other sources of directional heating may be applied. Other known or yet to be developed equivalent heat sources are contemplated.

The present illustrated embodiment includes the use of an external vacuum source 180. A suction hose 182 is connected the vacuum source 180 and is particularly adapted to extend into the housing assembly through the slots 116, whereby it functions to remove melted solder from the housing assembly. In the present embodiment, the vacuum source 180 and the third heating source 170 are coupled as part of a suitable single commercial unit. Clearly, separate sources of heat and vacuum may be applied. A jet 190 of localized cooling air may be applied to the exterior of the housing assembly.

After having described one preferred construction of the heating system according to the present invention, its operation is believed to be self-evident. To supplement such a description, however, a brief description of the method as implemented by the foregoing reflow heating system is set forth below.

Basically, the heating housing assembly is arranged to generally encapsulate one or more microelectronic assemblies within the internal thermal processing chamber that are mounted on the printed circuit board. The volume of the thermal processing chamber may be varied depending on the situation. The first heating source is selectively coupled to the housing assembly and positioned within the thermal processing chamber. Preferably, a force-applying mechanism is for resiliently urging the heating platen into engagement with the microelectronic assembly 102. A vacuum is applied to the microelectronic assembly thru the heating platen to retain the latter in contact with the former. As a result, the removal of microelectronic assemblies from the circuit board following complete reflow is expeditiously accomplished. The second and/or third heating assemblies may be applied as necessary to complete the reflow process for the microelectronic assembly in a timely and known manner.

The embodiments and examples set forth herein were presented to explain best the present invention and its practical applications, thereby enabling those skilled in the art to make and use the invention. However, those skilled in the art will recognize that the foregoing description and examples have been presented for the purposes of illustration and example only. The description set forth is not intended to be exhaustive or to limit the invention to the precise forms disclosed. In describing the above-preferred embodiments illustrated in the drawings, specific terminology has been used for the sake of clarity. However, the invention is not intended to be limited to the specific terms selected. It is to be understood that each specific term includes all technical equivalents that operate in a similar manner to accomplish a similar purpose. Many modifications and variations are possible in light of the above teachings without departing from the spirit and scope of the appended claims.

What is claimed is:

1. A solder reflow heating system comprising:
a heating housing assembly having an internal thermal processing chamber adapted to generally encapsulate at least a microelectronic assembly mounted on a substrate; a first heating source assembly coupled to the housing assembly and positioned within the thermal processing chamber, the first heating source assembly comprising at least a first heating element that is adapted to engage a surface of a microelectronic assembly so as to apply heat sufficient to melt solder on a microelectronic assembly; and, the first heating source assembly is biased by a force-applying assembly into engagement with a microelectronic assembly.

2. The heating system of claim 1 wherein the force-applying assembly includes a spring-biasing mechanism that is adapted to urge the first heating element into biased engagement with a microelectronic assembly.

3. The heating system of claim 1 wherein the housing assembly is constructed to be adjustable in terms of varying the volume of the thermal processing chamber.

4. The heating system of claim 1 wherein the housing assembly is comprised of thermal insulation glass.

5. The heating system of claim 1 further including a second heating source that is spaced from the substrate upon which is mounted the microelectronic assembly, and is operable to apply heat to the microelectronic assembly.

6. The heating system set forth in claim 1 further including a third heating source including a source of heated fluid adapted to be selectively directed at the microelectronic assembly within the thermal processing chamber.

7. The heating system of claim 6 further including an elongated slotted opening that allows introduction of the third heating source.

8. The heating system of claim 1 wherein the housing assembly is replaceably mounted on a substrate.

9. The heating system of claim 2 further including a source of vacuum in communication with a microelectronic assembly and being activated to remove a microelectronic assembly from a substrate following solder reflow.

10. The heating system of claim 9 wherein the source of vacuum is in communication to a microelectronic assembly through at least the first heating element.

11. The heating system of claim 5 wherein the second heating source includes a radiant heat source.

12. The heating system of claim 6 wherein the housing assembly further includes at least one slotted opening allowing insertion, removal, and transportation of the third heating source along an extent of a microelectronic assembly.

13. The heating system of claim 9 wherein the source of vacuum, the spring-biasing mechanism, and the first heating source are coupled together in a single mounting unit.

14. The heating system of claim 13 wherein the single mounting unit further includes a pair of coextensive tubular portions wherein one of the tubular portions is in vacuum communication with the first heating element, and the other tubular portion houses the spring-biasing mechanism.

15. The heating system of claim 13 wherein the heating element includes at least a passage for allowing the establishment of vacuum between the first heating element and at least a surface of a microelectronic assembly.

16. The heating system of claim 13 includes a second heating source for applying convective heat to a bottom surface of a substrate beneath a mounted microelectronic assembly.

17. The heating system set forth in claim 1 further including a localized cooling source adjacent the heating housing assembly.

18. The heating system set forth in claim 1 wherein the heating housing assembly is portable.

19. The heating system set forth in claim 1 further including a suction device capable of being moved within the thermal processing chamber for removing solder.

20. A reflow method comprising:
generally encapsulating at least a microelectronic assembly mounted on a substrate by a heating housing assembly having an internal thermal processing chamber;
engaging at least one or more surfaces of a microelectronic assembly by a first heating element so as to apply heat sufficient to melt solder associated with a microelectronic assembly; and,
providing a first biasing force for urging the first heating element into engagement with a microelectronic assembly.

21. The heating method of claim 20 further comprising applying heat from a second source of heat to a microelectronic assembly by radiant heating.

22. The heating method of claim 20 further comprising applying at least a partial vacuum to a microelectronic assembly so as to lift the latter from the substrate following solder reflow.

23. The heating method set forth in claim 22 further comprising applying heat from a third heating source which third heating source provides a directional source of heat that is movable relatively to the encapsulated microelectronic assembly.

24. The heating method of claim 20 further comprising adjusting the size of the internal heating chamber for encapsulating different sized microelectronic assemblies.

25. The heating method of claim 20 wherein the biasing engagement is achieved by applying a biasing force sufficient to keep the heating element in a heat transfer arrangement with a microelectronic assembly.

26. The heating method of claim 22 wherein the partial vacuum is applied through the first heating element.
